(19) United States
(12) Patent Application Publication
(10) Pub. No.: US 2025/0124359 A1
(43) Pub. Date: Apr. 17, 2025

(54) Distributed EV Charging Systems and Methods

(71) Applicant: Plug P2P, Inc., Birmingham, MI (US)

(72) Inventor: Amal Campbell, Birmingham, MI (US)

(21) Appl. No.: 18/914,244

(22) Filed: Oct. 13, 2024

Related U.S. Application Data
(60) Provisional application No. 63/590,121, filed on Oct. 13, 2023.

(51) Int. Cl. G06Q 10/02; B60L 53/65; B60L 53/66; G06V 20/62

(52) U.S. Cl. CPC G06Q 10/02; B60L 53/65; B60L 53/66; G06V 20/63; G06V 2201/08

(57) ABSTRACT

A vehicle includes a battery, one or more memories, and one or more processors. The battery is configured to provide power to propel the vehicle. The one or more processors are configured to execute instructions that are stored in the one or more memories. The instructions, when executed, cause the one or more processors to send data indicative of a plug type for charging the battery of the vehicle and a location of the vehicle, receive preferences for a user of the vehicle, receive identifying information for provider charging stations that are matched to the vehicle, display the identifying information for each of the provider charging stations that are matched to the vehicle in an order, and causing one of the provider charging stations to be reserved for future use by the vehicle.

### CROSS-REFERENCE TO RELATED APPLICATIONS

This application claims the benefit of U.S. Provisional Application No. 63/590,121, filed on Oct. 13, 2023, the content of which is hereby incorporated herein in its entirety for all purposes.

### FIELD

Some implementations are generally related to electric vehicle (EV) charging, and, in particular, to distributed EV charging networks for allocation of charging infrastructure.

### BACKGROUND

Vehicles (e.g., electric vehicles (EVs)) may utilize power from a battery to propel the vehicle along a trajectory. Utilizing power from the battery depletes the battery and thus may require charging (e.g., recharging) via, for example, charging infrastructure. Increases in EV implementation has led to an increase in the use of charging infrastructure. Charging infrastructure may be incompatible with certain EVs, and vice versa. Charging infrastructure is often distributed across geographic regions.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

One aspect of the disclosure is a vehicle that includes a battery, one or more memories, and one or more processors. The battery is configured to provide power to propel the vehicle. The one or more processors are configured to execute instructions that are stored in the one or more memories, wherein the instructions, when executed, cause the one or more processors to send data indicative of a plug type for charging the battery of the vehicle and a location of the vehicle. When executed, the instructions may further cause the one or more processors to receive preferences for a user of the vehicle, the preferences including at least one of a rating associated with a charging station, a presence of an animal proximate the charging station, or the presence of a camera proximate the charging station. When executed, the instructions may further cause the one or more processors to receive identifying information for provider charging stations that are matched to the vehicle based on the plug type of the vehicle matching a receptacle type for each of the provider charging stations, based on the location of the vehicle relative to a location of each of the provider charging stations, and based on the preferences. When executed, the instructions may further cause the one or more processors to display the identifying information for each of the provider charging stations that are matched to the vehicle in an order based at least on a distance between the location of the vehicle and the location of each of the provider charging stations. When executed, the instructions may further cause the one or more processors to cause a reservation of at least one of the provider charging stations for future use by the vehicle.

Another aspect of the disclosure is a device associated with an electric vehicle that includes one or more memories and one or more processors. The one or more processors are configured to execute instructions that are stored in the one or more memories, wherein the instructions, when executed, cause the one or more processors to send data indicative of a charger compatibility for the electric vehicle and a location of the electric vehicle. The instructions, when executed, may further cause the one or more processors to send preferences for a user of the electric vehicle, the preferences including at least one of a rating associated with a charging station, a presence of an animal proximate the charging station, or the presence of a camera proximate the charging station. The instructions, when executed, may further cause the one or more processors to display one or more provider charging stations that are matched to the device based on the charger compatibility matching a charger type for the one or more provider charging stations, based on the location of the electric vehicle, and based on the preferences, wherein the one or more provider charging stations are displayed in a sorted order based at least on a distance between the electric vehicle and each of the one or more provider charging stations. The instructions, when executed, may further cause a provider charging station from the one or more provider charging stations to be reserved for future use by the electric vehicle.

Another aspect of the disclosure is a method that includes receiving, from a provider device, data indicative of a receptacle type for a charging station, an availability of the charging station, and a location of the charging station. The method may also include confirming the receptacle type based on one or more images of the charging station. The method may also include receiving additional information for the charging station, the additional information including at least one of a rating associated with the charging station, a presence of an animal proximate the charging station, or the presence of a camera proximate the charging station. The method may also include matching the charging station to a driver device based on the receptacle type matching a plug type for an electric vehicle that is associated with the driver device, based on the availability of the charging station, based on the location of the charging station, and based on the additional information. The method may also include reserving the charging station for future use by the electric vehicle.

### BRIEF DESCRIPTION OF THE DRAWINGS

FIG. 1 is a block diagram of an example system and a network environment which may be used for one or more implementations described herein.

FIG. 2 is a flowchart of an example method for a charging host in accordance with some implementations.

FIG. 3 is a diagram of an example graphical user interface (GUI) for a charging host in accordance with some implementations.

FIG. 4 is a diagram of an example graphical user interface (GUI) for a charging host in accordance with some implementations.

FIG. 5 is a diagram of an example graphical user interface (GUI) for a charging host in accordance with some implementations.

FIG. 6 is a diagram of an example graphical user interface (GUI) for a charging host in accordance with some implementations.

FIG. 7 is a flowchart of an example method for utilizing a peer-to-peer charger/plug receptacle in accordance with some implementations.

FIG. 8 is a diagram of an example graphical user interface (GUI) for a charger user in accordance with some implementations.

FIG. 9 is a diagram of an example graphical user interface (GUI) for a charger user in accordance with some implementations.

FIG. 10 is a diagram of an example graphical user interface (GUI) for a charger user in accordance with some implementations.

FIG. 11 is a diagram of an example graphical user interface (GUI) for a charger user in accordance with some implementations.

FIG. 12 is a diagram showing examples of Type 2 chargers for use with an implementation described herein.

FIG. 13 is a diagram showing examples of a Type 3 chargers for use with an implementation described herein.

FIG. 14 is a block diagram of an example computing device which may be used for one or more implementations described herein.

FIG. 15 is a diagram of an example graphical user interface (GUI) for a charger user to scan a VIN in accordance with some implementations.

FIG. 16 is a diagram of an example graphical user interface (GUI) for a charger user to manually enter a VIN in accordance with some implementations.

FIG. 17 is a diagram of an example graphical user interface (GUI) for a charger user verifying a VIN in accordance with some implementations.

### DETAILED DESCRIPTION

The present disclosure describes systems and methods for deploying and operating distributed electric vehicle (EV) charging networks for the allocation of charging infrastructure. Charging infrastructure (e.g., charging stations, electrical outlets, etc.) is often distributed geographically based on, for example, the availability of electrical systems that can support the electrical power loads required to implement the charging infrastructure. Different charging infrastructure may have different characteristics (e.g., voltage requirements, power supply capabilities, plug type, etc.). Similarly, vehicles that use one or more batteries as a means of propulsion (e.g., electric vehicles, hybrid vehicles, etc.) may have different characteristics (e.g., plug type requirements, power receipt capabilities, etc.). Accordingly, certain charging infrastructure may be compatible with some vehicles and may be incompatible with other vehicles. Stated differently, certain vehicles may be compatible with some charging infrastructure and may be incompatible with other charging infrastructure.

For example, some charging infrastructure (e.g., a charging station) may include a J1772 type charger plug and be configured to supply (e.g., output) 1.4 kilowatts of power (e.g., may be a Level 1 type charger), while other charging infrastructure (e.g., another charging station) may include a NACS type charger plug and be configured to supply (e.g., output) 10.4 kilowatts of power (e.g., may be a Level 2 type charger). As another example, some charging infrastructure (e.g., an electrical outlet) may include a NEMA 5-15 type receptacle and be configured to supply (e.g., output) 1.4 kilowatts of power (e.g., may be a Level 1 type charger), while other charging infrastructure (e.g., another electrical outlet) may include a NEMA 14-50 type receptacle and be configured to supply (e.g., output) 8.3 kilowatts of power (e.g., may be a Level 2 type charger). Furthermore, as an example, some vehicles (e.g., an EV) may be configured to receive a maximum of 2 kilowatts (e.g., may be configured for use with a Level 1 type charger) and may be equipped with a J1772 receptacle, while other vehicles (e.g., another EV) may be configured to receive a maximum of 350 kilowatts (e.g., may configured for use with a DC Fast Charger) and may be equipped with a CHAdeMO type receptacle. As another example, some vehicles (e.g., an EV) may be configured to receive a maximum of 2 kilowatts (e.g., may be configured for use with a Level 1 type charger) and may be equipped with a J1772 receptacle, while other vehicles (e.g., another EV) may be configured to receive a maximum of 19 kilowatts (e.g., may be configured for use with a Level 2 type charger) and may also be equipped with a J1772 receptacle.

Variability in the properties and capabilities of charging infrastructure and the properties and requirements of EVs results in difficulty reliably predicting which particular charging infrastructure a driver of an EV may select. Aggregation of multiple data related to the EV—e.g., power consumption, power draw requirements, and distance to nearest charging infrastructure—may be assessed in view of multiple data related to known charging infrastructure—e.g., power output, charger type, and receptacle type—to dynamically predict a selection of particular charging infrastructure by the driver of the EV.

Some implementations include peer-to-peer EV charging methods and systems. The system can include a mobile application installed on a client device (e.g., a host mobile device or a guest mobile device), a web application, or other type of application accessible to a host or guest user. A server system can coordinate adding new users, matching guests to hosts, storing reviews, etc. In some implementations, the peer-to-peer EV charging application can be installed and executed on a computer system within an EV as a third-party application. In some implementations, the peer-to-peer EV charging application can be integrated into an EV computer system as part of the OEM EV.

Some implementations of the disclosed subject matter include numerous advantages. For example, some implementations provide a peer-to-peer EV charging marketplace that augments limited existing public EV chargers (<150K) by making millions of existing privately owned EV chargers and privately owned plug receptacles (electrical outlets) potentially available to EV drivers needing a charge. Also, some implementations can permit EV drivers with portable EV charging equipment to locate, reserve and pay to access privately owned plug receptacles (e.g., electrical outlets) to charge their EV anywhere and everywhere. Further, some implementations can empower owners of underutilized electrical infrastructure, including private owners of EV chargers and private owners of various compatible electrical plug receptacles (electrical outlets), to monetize their underutilized EV charging-capable assets.

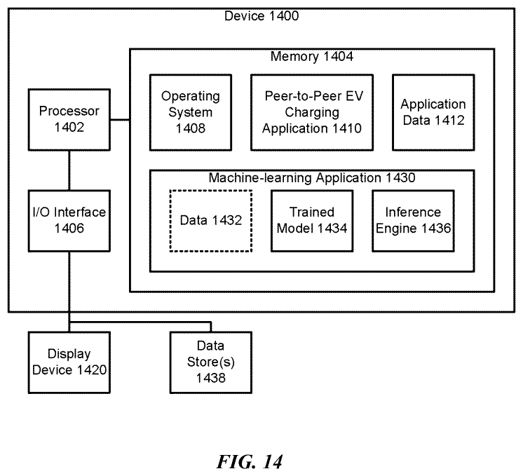

When performing peer-to-peer EV charging functions, it may be helpful for a system to suggest an EV charger of compatible type and electrical characteristics to select for immediate charging or for a scheduled charging in the future. To make predictions or suggestions, a probabilistic model (or other model as described below in conjunction with FIG. 14) can be used to make an inference (or prediction) about aspects of peer-to-peer EV charging such as a charger to schedule. Other aspects can be predicted or suggested as described below.

The probabilistic model can be trained with data including previous EV charging data. The systems and methods provided herein may overcome one or more deficiencies of some conventional EV charger systems and methods. For example, conventional public chargers may not be readily available.

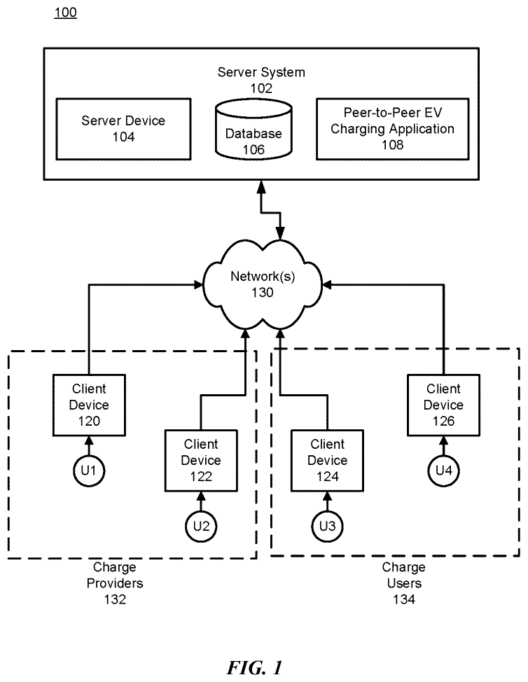

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and peer-to-peer EV charging application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication between devices, e.g., using peer-to-peer wireless protocols.

The clients can include providers of EV chargers or plug receptacles 132 (e.g., 120 and 122) and users of EV chargers or plug receptacles 134 (e.g., 124 and 126). In some cases, a user can be both a provider of a charger or plug receptacle and a user of other chargers or plug receptacles.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide peer-to-peer EV charging.

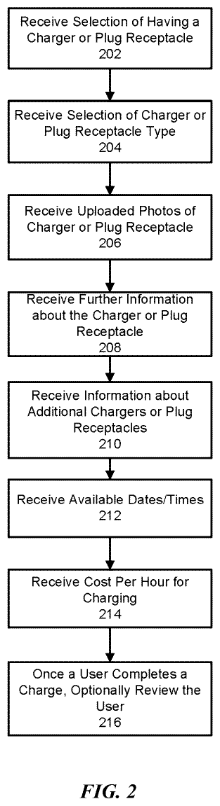

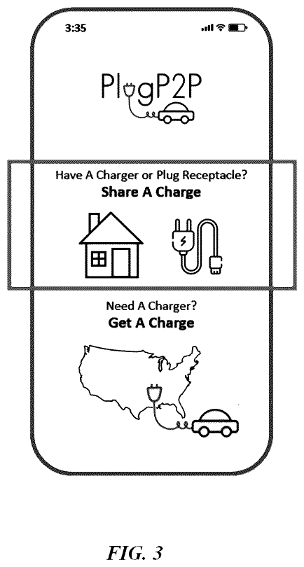

FIG. 2 is a flowchart of an example method for a charging host within a peer-to-peer EV charging system in accordance with some implementations. Processing begins at 202, where a selection of having a charger/plug receptacle available is received. For example, a user may download the application to their mobile device and select the option of having a charger/plug receptacle such as that shown in FIG. 3. Processing continues to 204.

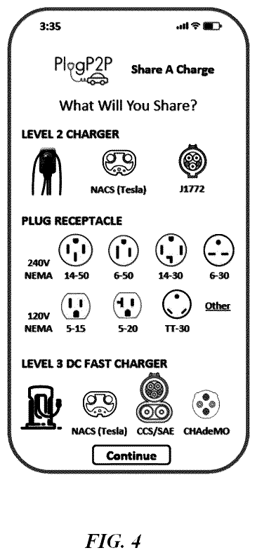

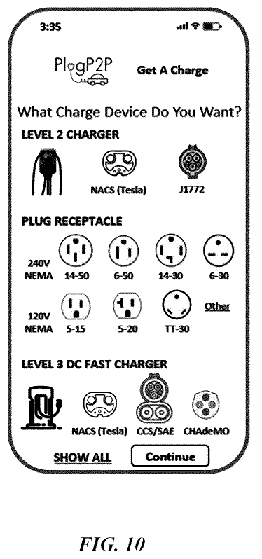

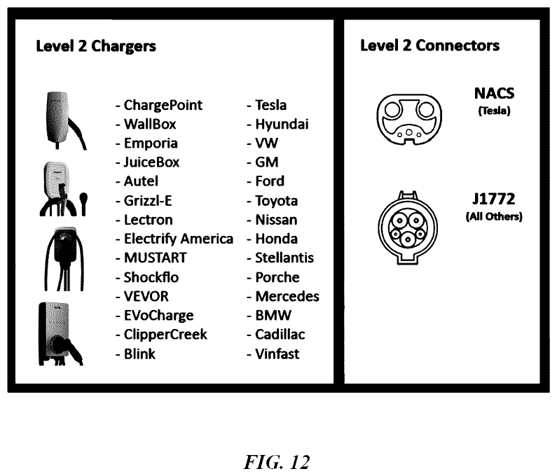

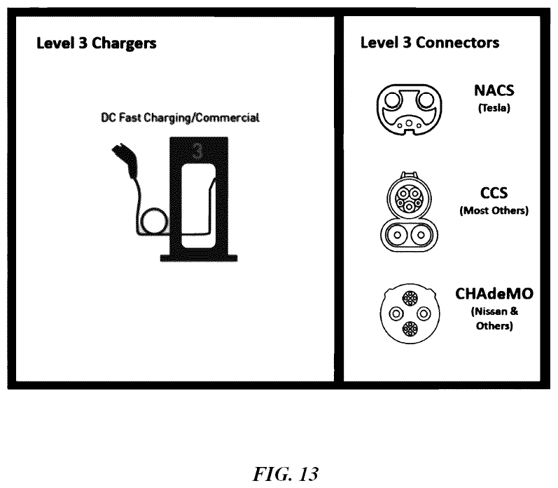

At 204, a selection of a charger or plug receptacle type is received from the user. For example, as shown in FIG. 4 the user is given the option of selecting a privately owned Level 2 EV charger with NACS (Tesla) or J1772 connector, various 240V or 120V plug receptacles, or Level 3 EV chargers which may be available on private property now or at some future date. Various examples of plug receptacle types are shown in FIGS. 4 and 10 and various charger types are shown in FIGS. 12 and 13. The peer-to-peer EV charging system described herein can be used with known or later developed chargers or plug receptacles. Processing continues to 206.

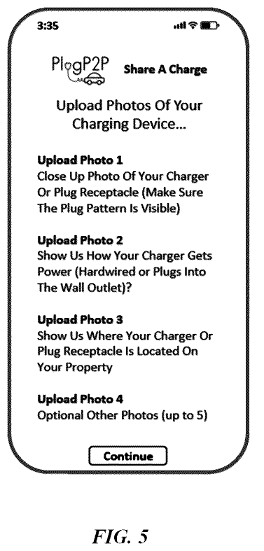

At 206, photos of the user's charger or plug receptacle are received. For example, as shown in FIG. 5, required photos can include a close-up photo of the user's charger or plug receptacle, where the plug pattern is visible, and a photo showing the location of the charger or plug receptacle on the user's property. A given number (e.g., 3) of additional photos can be optionally provided. In some implementations, an AI/ML model including computer vision can be leveraged to assess images shared by a host to confirm that the host description of charging assets is accurate and to match guest EVs to most relevant and most proximate available host charging resources. Processing continues to 208.

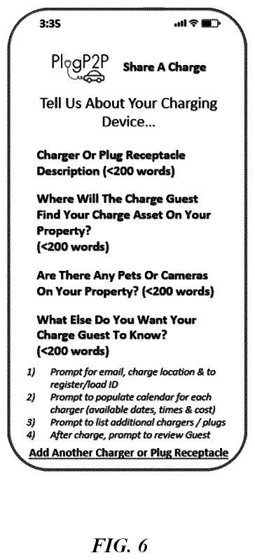

At 208, further information about a charger or plug receptacle can be received. For example, as shown in FIG. 6, the additional information can include, for example, a charger or plug receptacle description, where the charging guest will find the charger or plug receptacle on the property, whether there are any pets or cameras on the property, and anything else the host wants a guest to know. Charging hosts can also optionally add additional chargers and plug receptacles (210), calendar of date/time availability information for each charger or plug receptacle (212), and dollar per hour for each charger or plug receptacle (214).

Once a guest has used the host's charger or plug receptacle, the host can optionally leave a review of the guest.

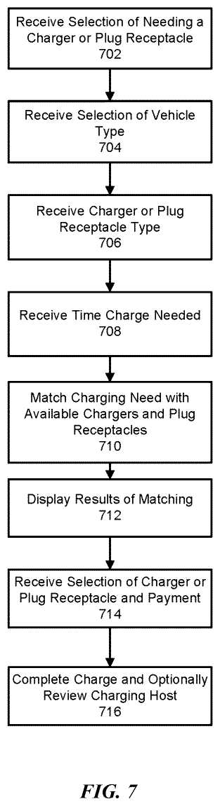

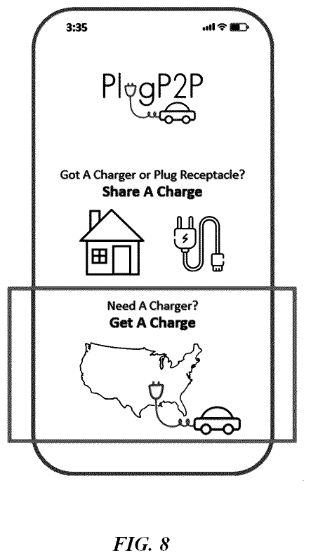

FIG. 7 is a flowchart of an example method for utilizing a peer-to-peer charger or plug receptacle within a peer-to-peer EV charging in accordance with some implementations. Processing begins at 702, where a selection of needing a charger or plug receptacle is received. For example, as shown in FIG. 8, the user can select the Get A Charge element. Processing continues to 704.

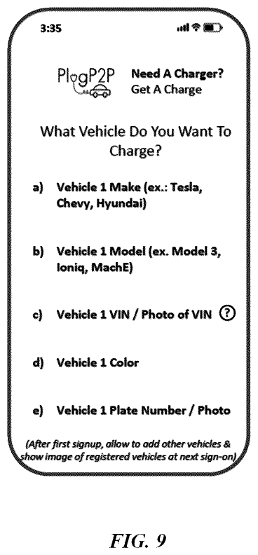

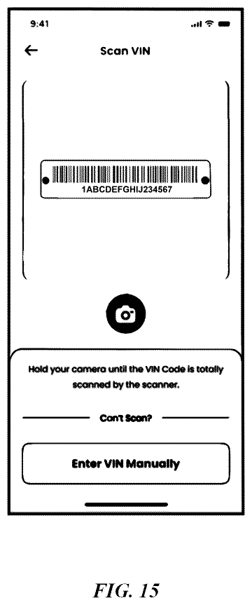

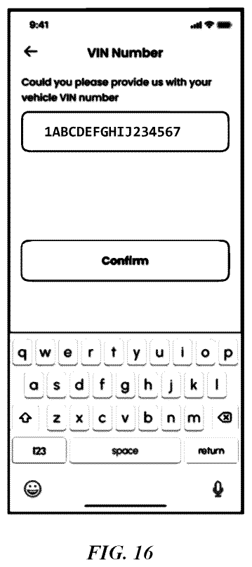

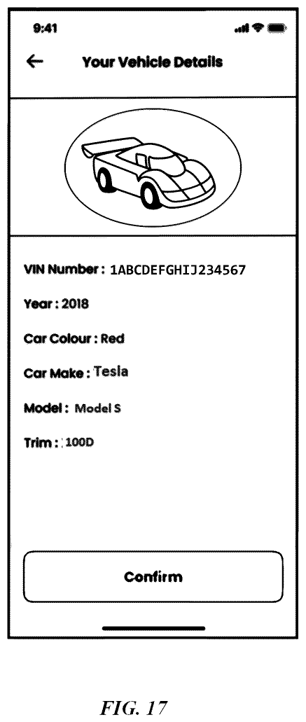

At 704, information about the user's vehicle is received. Guests can provide vehicle information by scanning the Vehicle Information Number (VIN) or entering the VIN manually. For example, as shown in FIG. 9, the received vehicle information can include one or more of vehicle make, vehicle model, vehicle VIN (via scan or text entry), vehicle color, and vehicle plate number/photo. FIGS. 15-17 show the process of inputting and verifying a vehicle VIN including reading the VIN automatically (FIG. 15) or entering the VIN manually (FIG. 16) and confirming/verifying vehicle details determined from scanned or entered VIN (FIG. 17). As shown in FIG. 15, the guest can have an option to scan their vehicle VIN to automatically identify their vehicle and provide vehicle details when they register to use the application. Scanning the VIN can be faster, easier, more reliable, and more accurate than entering the VIN manually. As shown in FIG. 16, in some instances, the VIN scan feature may not be available or preferred. In these instances, the user will still have the ability to enter the VIN manually. As shown in FIG. 17, the VIN can be utilized to summarize vehicle data and confirm and display an image of the vehicle. The vehicle image and description will be shared with the host to inform them of what vehicle will be arriving to charge at their property. This will help increase awareness and enhance safety and security. After the first signup, the user can optionally add another vehicle. Processing continues to 706.

At 706, the type of charger or plug receptacle needed is received. For example, as shown in FIG. 10, the user can select various Level 2, plug receptacles, or other types of chargers. Processing continues to 708.

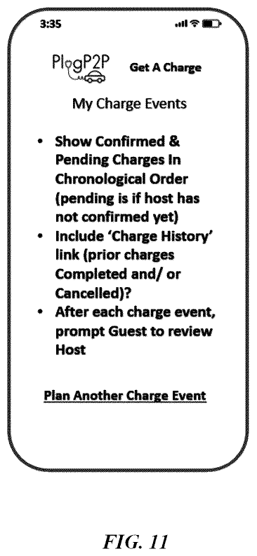

At 708, when a charger or plug receptacle is needed is received. For example, as shown in FIG. 11, the user can select to find a charger or plug receptacle near them or plan a future charge. In some implementations, a user can provide a planned trip and the system can recommend chargers or plug receptacles for the trip route and timing. In some implementations, the charger or plug receptacle locations can be selected by the user. In some implementations, the charger or plug receptacle locations can be recommend based on the current location information of the user's device. Processing continues to 710.

At 710, the guest user's charging need (e.g., as defined by the data received in 702-708) is matched against the data of one or more charger/plug receptacle hosts. Matching can include exact matching or nearest matching data. Matching can include comparing multiple factors including location, date/time charge needed, vehicle type, charger type, plug receptacle type, etc. More than one match result may be provided. The matching results can be sorted based on one or more factors such as distance to host charger/plug receptacle, compatibility with vehicle, type of charger or plug receptacle (e.g., Type 2/3 or plug in), cost of charging, rating of host, etc. In general, any data maintained about the host and/or guest can be used to perform matching. Further, sorting matching chargers or plug receptacles can be performed or enhanced by an AI/ML model that can predict which charger or chargers or plug receptacles are most likely to be selected by the guest user. In some implementations, the sorting order of the matching chargers/plug receptacles can be based on a probability output of the AI/ML model predicting the probability that a user will select a given charger/plug receptacle. Processing continues to 712.

At 712, the results of the matching are displayed for the guest user. The display can be sorted according to the description above in 710. Processing continues to 714.

At 714, a selection of a charger or plug receptacle is received from the guest user. Once a selection is made, the guest user makes an initial payment for the charger/plug receptacle (e.g., for a given amount of charge time or distance). The initial charge can be extended upon confirmed availability of the charger/plug receptacle and payment for the additional charge. Processing continues to 716.

In some implementations, rather than the selection of a charger or plug receptacle being received from the guest user, a charger or plug receptacle may be automatically selected based on a prediction of which charger or plug receptacle is most likely to be selected by the guest user (e.g., using an AI/ML model as described above). In some implementations, a charger or plug receptacle may be automatically selected based on the order by which the matching chargers or plug receptacles are sorted. In some implementations, a charger or plug receptacle may be automatically selected based on a current activity of the guest user (e.g., based on a temporal duration or a location of the current activity of the guest user). For example, where the guest user is attending a short appointment (e.g., an appointment lasting less than a temporal threshold), a particular charging station or receptacle may be automatically selected, whereas where the guest user is attending a long appointment (e.g., an appointment lasting longer than the temporal threshold), a different charging station or receptacle may be automatically selected. In some implementations, a recommendation for a charger or plug receptacle may be provided to the guest user based on a prediction of which charger or plug receptacle is most likely to be selected by the guest user (e.g., using an AI/ML model as described above), whereby the guest user may select the charger or plug receptacle by confirming the recommendation.

Prior to processing continuing to 716, in some implementations, the selection of a charger or plug receptacle may cause (e.g., automatically cause) operations of the EV and/or the charger or receptacle to be controlled. In some implementations, the selection of a charger or plug receptacle may automatically cause the charger or plug receptacle to be scheduled for use (e.g., future use) by the guest user. For example, the selection of a charger or plug receptacle may automatically cause a calendar associated with the host user and/or the charger or receptacle to indicate a scheduled time at which the guest user will utilize the charger or receptacle. Additionally, the selection of a charger or plug receptacle may automatically cause information about the charger or plug receptacle (e.g., the additional information described above) to be displayed on the user's device. Furthermore, in implementations where the EV has autonomous driving capabilities (e.g., partial or limited autonomous driving capabilities) the selection of a charger or plug receptacle may automatically cause the EV to drive to the selected charger or plug receptacle. For example, where the EV includes components operable to enable autonomous driving (e.g., a controller, sensors, etc.), upon selection of a charger or plug receptacle, the EV may automatically drive to the charger or receptacle with, without, or with limited input from the guest user. Furthermore, where a charger or receptacle has been scheduled for future use by the guest user, the EV may automatically drive to the charger or receptacle at or before the scheduled time. In some implementations, the guest user may provide an input to approve (e.g., permit) the EV to automatically drive to the charger or receptacle at or before the scheduled time. Where the EV has autonomous driving capabilities, the EV may autonomously drive to a position directly adjacent to the selected charger or plug or may drive to a position that is spaced from the charger or plug to be manually driven to the position directly adjacent to the selected charger by a user (e.g., the guest user or the host user).

At 716, once the charge is complete, the guest user can optionally leave a review of the host. As used herein, a review (by guest or host) can include one or more of a rating (e.g., on a scale of 5 stars), a written portion, pictures, video, and audio.

In implementations where the EV has autonomous driving capabilities, once the charge is complete, the EV may automatically drive away from the charger or receptacle. For example, once the charge is complete, the EV may automatically drive to the guest user or to the home of the guest user.

Various implementations of features described herein can use any type of system and/or service. Any type of electronic device can make use of the features described herein. Some implementations can provide one or more features described herein on client or server devices disconnected from or intermittently connected to computer networks.

FIG. 14 is a block diagram of an example device 1400 which may be used to implement one or more features described herein. In one example, device 1400 may be used to implement a client device, e.g., any of client devices 120-126 shown in FIG. 1. Alternatively, device 1400 can implement a server device, e.g., server device 104, etc. In some implementations, device 1400 may be used to implement a client device, a server device, or a combination of the above. Device 1400 can be any suitable computer system, server, or other electronic or hardware device as described above.

One or more methods described herein (e.g., as shown in FIGS. 2 and/or 7) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 1400 includes a processor 1402, a memory 1404, and I/O interface 1406. Processor 1402 can be one or more processors and/or processing circuits to execute program code and control basic operations of the device 1400. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 1402 may include one or more co-processors that implement neural-network processing. In some implementations, processor 1402 may be a processor that processes data to produce probabilistic output, e.g., the output produced by processor 1402 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1404 is typically provided in device 1400 for access by the processor 1402 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 1402 and/or integrated therewith. Memory 1404 can store software operating on the server device 1400 by the processor 1402, including an operating system 1408, machine-learning application 1430, peer-to-peer EV charging application 1410, and application data 1412. Other applications may include applications such as a data display engine, web hosting engine, image display engine, notification engine, social networking engine, etc. In some implementations, the machine-learning application 1430 and peer-to-peer EV charging application 1410 can each include instructions that enable processor 1402 to perform functions described herein, e.g., some or all of the methods of FIGS. 2 and/or 7.

The machine-learning application 1430 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a peer-to-peer EV charging application 1410 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 1430 may utilize Bayesian classifiers, support vector machines, neural networks, or other learning techniques. In some implementations, machine-learning application 1430 may include a trained model 1434, an inference engine 1436, and data 1432. In some implementations, data 432 may include training data, e.g., data used to generate trained model 1434. For example, training data may include any type of data suitable for training a model for peer-to-peer EV charging tasks, such as images of charger connectors or electrical outlets (plug receptacles), charger hosting and/or guest data, review information, labels, thresholds, etc. associated with peer-to-peer EV charging tasks described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 1434, training data may include such user data. In implementations where users permit use of their respective user data, data 1432 may include permitted data.

In some implementations, data 1432 may include collected data such as previous charging matching, reservations, and/or reviews. In some implementations, training data may include synthetic data generated for the purpose of training, such as data that is not based on user input or activity in the context that is being trained, e.g., data generated from simulated conversations, computer-generated images, etc. In some implementations, the training data can include images of charger connectors or electrical outlets such that the AI/ML model can be trained to utilize computer vision to assess images shared by host to confirm host description of charging asset and to match EVs to most relevant and most proximate available charging resources. In some implementations, machine-learning application 1430 excludes data 1432. For example, in these implementations, the trained model 1434 may be generated, e.g., on a different device, and be provided as part of machine-learning application 1430. In various implementations, the trained model 1434 may be provided as a data file that includes a model structure or form, and associated weights. Inference engine 1436 may read the data file for trained model 1434 and implement a neural network with node connectivity, layers, and weights based on the model structure or form specified in trained model 1434.

Machine-learning application 1430 also includes a trained model 1434. In some implementations, the trained model 1434 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 1432 or application data 1414. Such data can include, for example, images, e.g., when the trained model is used for peer-to-peer EV charging functions. Subsequent intermediate layers may receive as input output of nodes of a previous layer per the connectivity specified in the model form or structure. These layers may also be referred to as hidden layers. A final layer (e.g., output layer) produces an output of the machine-learning application. In some implementations, model form or structure also specifies a number and/or type of nodes in each layer.

In different implementations, the trained model 1434 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 1434 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 1432, to produce a result.

For example, training may include applying supervised learning techniques. In supervised learning, the training data can include a plurality of inputs (e.g., peer-to-peer EV charging data) and a corresponding expected output for each input. Based on a comparison of the output of the model with the expected output, values of the weights are automatically adjusted, e.g., in a manner that increases the probability that the model produces the expected output when provided similar input.

In some implementations, training may include applying unsupervised learning techniques. In unsupervised learning, only input data may be provided and the model may be trained to differentiate data, e.g., to cluster input data into a plurality of groups, where each group includes input data that are similar in some manner.

In another example, a model trained using unsupervised learning may cluster words based on the use of the words in data sources. In some implementations, unsupervised learning may be used to produce knowledge representations, e.g., that may be used by machine-learning application 1430. In various implementations, a trained model includes a set of weights, or embeddings, corresponding to the model structure. In implementations where data 1432 is omitted, machine-learning application 1430 may include trained model 1434 that is based on prior training, e.g., by a developer of the machine-learning application 1430, by a third-party, etc. In some implementations, trained model 1434 may include a set of weights that are fixed, e.g., downloaded from a server that provides the weights.

Machine-learning application 1430 also includes an inference engine 1436. Inference engine 1436 is configured to apply the trained model 1434 to data, such as application data 1414, to provide an inference. In some implementations, inference engine 1436 may include software code to be executed by processor 1402. In some implementations, inference engine 1436 may specify circuit configuration (e.g., for a programmable processor, for a field programmable gate array (FPGA), etc.) enabling processor 1402 to apply the trained model. In some implementations, inference engine 1436 may include software instructions, hardware instructions, or a combination. In some implementations, inference engine 1436 may offer an application programming interface (API) that can be used by operating system 1408 and/or peer-to-peer EV charging application 1410 to invoke inference engine 1436, e.g., to apply trained model 1434 to application data 1414 to generate an inference.

Machine-learning application 1430 may provide several technical advantages. For example, when trained model 1434 is generated based on unsupervised learning, trained model 1434 can be applied by inference engine 1436 to produce knowledge representations (e.g., numeric representations) from input data, e.g., application data 1412. For example, a model trained for peer-to-peer EV charging tasks may produce predictions and confidences for given input information about peer-to-peer EV charging. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 1436.

In some implementations, knowledge representations generated by machine-learning application 1430 may be provided to a different device that conducts further processing, e.g., over a network. In such implementations, providing the knowledge representations rather than the images may provide a technical benefit, e.g., enable faster data transmission with reduced cost.

In some implementations, machine-learning application 1430 may be implemented in an offline manner. In these implementations, trained model 1434 may be generated in a first stage and provided as part of machine-learning application 1430. In some implementations, machine-learning application 1430 may be implemented in an online manner. For example, in such implementations, an application that invokes machine-learning application 1430 (e.g., operating system 1408, one or more of peer-to-peer EV charging application 1410 or other applications) may utilize an inference produced by machine-learning application 1430, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 1434, e.g., to update embeddings for trained model 1434.

In some implementations, machine-learning application 1430 may be implemented in a manner that can adapt to particular configuration of device 1400 on which the machine-learning application 1430 is executed. For example, machine-learning application 1430 may determine a computational graph that utilizes available computational resources, e.g., processor 1402. For example, if machine-learning application 1430 is implemented as a distributed application on multiple devices, machine-learning application 1430 may determine computations to be carried out on individual devices in a manner that optimizes computation. In another example, machine-learning application 1430 may determine that processor 1402 includes a GPU with a particular number of GPU cores (e.g., 1000) and implement the inference engine accordingly (e.g., as 1000individual processes or threads).

In some implementations, machine-learning application 1430 may implement an ensemble of trained models. For example, trained model 1434 may include a plurality of trained models that are each applicable to the same input data. In these implementations, machine-learning application 1430 may choose a particular trained model, e.g., based on available computational resources, success rate with prior inferences, etc. In some implementations, machine-learning application 1430 may execute inference engine 1436 such that a plurality of trained models is applied. In these implementations, machine-learning application 1430 may combine outputs from applying individual models, e.g., using a voting-technique that scores individual outputs from applying each trained model, or by choosing one or more particular outputs. Further, in these implementations, machine-learning applications may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 1408 or one or more other applications, e.g., peer-to-peer EV charging application 1410.

In different implementations, machine-learning application 1430 can produce different types of outputs. For example, machine-learning application 1430 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 1430 may produce an output video with a particular effect applied, e.g., rendered in a comic-book or particular artist's style, when trained model 1434 is trained using training data from the comic book or particular artist, etc. In some implementations, machine-learning application 1430 may produce an output based on a format specified by an invoking application, e.g., operating system 1408 or one or more applications, e.g., peer-to-peer EV charging application 1410. In some implementations, an invoking application may be another machine-learning application. For example, such configurations may be used in generative adversarial networks, where an invoking machine-learning application is trained using output from machine-learning application 1430 and vice-versa.

Any software in memory 1404 can alternatively be stored in any other suitable storage location or computer-readable medium. In addition, memory 1404 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 1404 and any other type of storage (magnetic disk, optical disk, magnetic tape, or other tangible media) can be considered “storage” or “storage devices.”

I/O interface 1406 can provide functions to enable interfacing the server device 1400 with other systems and devices. Interfaced devices can be included as part of the device 1400 or can be separate and communicate with the device 1400. For example, network communication devices, storage devices (e.g., memory and/or database 106), and input/output devices can communicate via I/O interface 1406. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 1406 can include one or more display devices 1420 and one or more data stores 1438 (as discussed above). The display devices 1420 that can be used to display content, e.g., a user interface of an output application as described herein. Display device 1420 can be connected to device 1400 via local connections (e.g., display bus) and/or via networked connections and can be any suitable display device. Display device 1420 can include any suitable display device such as an LCD, LED, or plasma display screen, CRT, television, monitor, touchscreen, 3-D display screen, or other visual display device. For example, display device 1420 can be a flat display screen provided on a mobile device, multiple display screens provided in a goggles or headset device, or a monitor screen for a computer device.

The I/O interface 1406 can interface to other input and output devices. Some examples include one or more cameras which can capture images, including charger, charge connector, plug receptacle, and Vehicle Identification Number (VIN) images. Some implementations can provide a microphone for capturing sound (e.g., as a part of captured images, voice commands, etc.), audio speaker devices for outputting sound, or other input and output devices.

For ease of illustration, FIG. 14 shows one block for each of processor 1402, memory 1404, I/O interface 1406, and software blocks 1408, 1410, and 1430. These blocks may represent one or more processors or processing circuitries, operating systems, memories, I/O interfaces, applications, and/or software modules. In other implementations, device 1400 may not have all of the components shown and/or may have other elements including other types of elements instead of, or in addition to, those shown herein. While some components are described as performing blocks and operations as described in some implementations herein, any suitable component or combination of components of environment 100, device 1400, similar systems, or any suitable processor or processors associated with such a system, may perform the blocks and operations described.

In some implementations, logistic regression can be used for personalization. In some implementations, the prediction model can be handcrafted including hand selected labels and thresholds. The mapping (or calibration) from ICA space to a predicted precision within a space can be performed using a piecewise linear model.

In some implementations, the peer-to-peer EV charging system could include a machine-learning model (as described herein) for tuning the system to potentially provide improved accuracy. Inputs to the machine learning model can include ICA labels, an image descriptor vector that describes appearance and includes semantic information about peer-to-peer EV charging devices and infrastructure. Example machine-learning model input can include labels for a simple implementation and can be augmented with descriptor vector features for a more advanced implementation. Output of the machine-learning module can include a prediction of peer-to-peer EV charging such as a charger or plug receptacle that would be a good match for a given user.

One or more methods described herein (e.g., methods of FIGS. 2 and 7) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may be executed on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A vehicle, comprising:
a battery configured to provide power to propel the vehicle;
one or more memories; and
one or more processors that are configured to execute instructions that are stored in the one or more memories, wherein the instructions, when executed, cause the one or more processors to:
send data indicative of a plug type for charging the battery of the vehicle and a location of the vehicle;
receive preferences for a user of the vehicle, the preferences including at least one of a rating associated with a charging station, a presence of an animal proximate the charging station, or the presence of a camera proximate the charging station;
receive identifying information for provider charging stations that are matched to the vehicle based on the plug type of the vehicle matching a receptacle type for each of the provider charging stations, based on the location of the vehicle relative to a location of each of the provider charging stations, and based on the preferences;
display the identifying information for each of the provider charging stations that are matched to the vehicle in an order based at least on a distance between the location of the vehicle and the location of each of the provider charging station; and
cause a reservation of at least one of the provider charging stations for future use by the vehicle.

2. The vehicle of claim 1, wherein the identifying information for each of the provider charging stations that are matched to the vehicle is displayed in the order based on a probability of each of the provider charging stations being reserved for future use by the vehicle.

3. The vehicle of claim 1, wherein the instructions, when executed, further cause the one or more processors to:
send data indicative of a planned route for the vehicle,
wherein the provider charging stations are matched to the vehicle based further on the location of each of the provider charging stations relative to the planned route for the vehicle.

4. The vehicle of claim 1, wherein:
each of the provider charging stations has an availability;
the preferences include a range of times; and
the provider charging stations are matched to the vehicle based further on the availability being within the range of times.

5. The vehicle of claim 4, wherein the identifying information for each of the provider charging stations that are matched to the vehicle is displayed in the order based further on a difference between the range of times and the availability.

6. A device associated with an electric vehicle, comprising:
one or more memories; and
one or more processors that are configured to execute instructions that are stored in the one or more memories, wherein the instructions, when executed, cause the one or more processors to:
send data indicative of a charger compatibility for the electric vehicle and a location of the electric vehicle;
send preferences for a user of the electric vehicle, the preferences including at least one of a rating associated with a charging station, a presence of an animal proximate the charging station, or a presence of a camera proximate the charging station;
display one or more provider charging stations that are matched to the device based on the charger compatibility matching a charger type for the one or more provider charging stations, based on the location of the electric vehicle, and based on the preferences, wherein the one or more provider charging stations are displayed in a sorted order based at least on a distance between the electric vehicle and each of the one or more provider charging stations; and
cause a provider charging station from the one or more provider charging stations to be reserved for future use by the electric vehicle.

7. The device of claim 6, wherein the preferences further include a range of values, and wherein the one or more provider charging stations are matched to the device based further on a rate for using each of the one or more provider charging stations being within the range of values.

8. The device of claim 6, wherein the preferences further include a value preference, and wherein the one or more provider charging stations are displayed in the sorted order based further on a difference between the value preference and a rate for using each of the one or more provider charging stations.

9. The device of claim 6, wherein the preferences further include a range of times, and the one or more provider charging stations are matched to the device based further on the range of times being with an availability of the one or more provider charging stations.

10. The device of claim 6, wherein the preferences further include a time preference, and wherein the one or more provider charging stations are displayed in the sorted order based further on a difference between the time preference and an availability of the one or more provider charging stations.

11. The device of claim 6, wherein the instructions, when executed, further cause the one or more processors to:
send data indicative of electrical characteristics for the electric vehicle,
wherein the one or more provider charging stations are matched to the device based further on the electrical characteristics for the electric vehicle being compatible with electrical characteristics for the one or more provider charging stations.

12. The device of claim 11, wherein the instructions, when executed, further cause the one or more processors to:
capture an image of a vehicle identification number for the electric vehicle; and
verify the electrical characteristics for the electric vehicle based on the image of the vehicle identification number for the electric vehicle.

13. A method, comprising:
receiving, from a provider device, data indicative of a receptacle type for a charging station, an availability of the charging station, and a location of the charging station;
confirming the receptacle type based on one or more images of the charging station;
receiving additional information for the charging station, the additional information including at least one of a rating associated with the charging station, a presence of an animal proximate the charging station, or the presence of a camera proximate the charging station;
matching the charging station to a driver device based on the receptacle type matching a plug type for an electric vehicle that is associated with the driver device, based on the availability of the charging station, based on the location of the charging station, and based on the additional information; and
reserving the charging station for future use by the electric vehicle.

14. The method of claim 13, wherein:
the charging station is one of multiple charging stations each having a receptacle type, an availability, and a location; and
matching the charging station to the driver device further comprises matching the multiple charging stations to the driver device based on the receptacle type for each of the multiple charging stations matching the plug type for the electric vehicle, based on the availability of each of the multiple charging stations, and based on the location of each of the multiple charging stations.

15. The method of claim 14, wherein matching the multiple charging stations to the driver device further comprises:
sorting the multiple charging stations that are matched to the driver device into an order based at least on a distance between the electric vehicle and the location of each of the multiple charging stations.

16. The method of claim 15, wherein sorting the multiple charging stations that are matched to the driver device in the order is based on a probability of the charging stations being reserved for future use.

17. The method of claim 14, further comprising:
displaying the multiple charging stations that are matched to the driver device on the driver device,
wherein reserving the charging station for future use comprises selecting one of the multiple of the charging stations on the driver device.

18. The method of claim 17, wherein the electric vehicle is the driver device.

19. The method of claim 13, further comprising:
receiving, from the provider device, data indicative of a charger type for the charging station,
wherein matching the charging station to the driver device is further based on the charger type for the charging station being compatible with the electric vehicle.

20. The method of claim 13, wherein confirming the receptacle type based on the one or more images of the charging station is performed using a machine learning model that compares the receptacle type received from the provider device with the one or more images of the charging station.
